(19) United States
(12) Patent Application Publication
(10) Pub. No.: US 2025/0320353 A1
(43) Pub. Date: Oct. 16, 2025

(54) RESIN COMPOSITION

(71) Applicant: NAN YA PLASTICS CORPORATION, Taipei City (TW)

(72) Inventors: Ching-Yao Yuan, Taipei City (TW); Wei-Ru Huang, Taipei City (TW); Hung-Yi Chang, Taipei City (TW); Chia-Lin Liu, Taipei City (TW)

(73) Assignee: NAN YA PLASTICS CORPORATION, Taipei City (TW)

(21) Appl. No.: 18/655,337

(22) Filed: May 6, 2024

(30) Foreign Application Priority Data
Apr. 16, 2024 (TW) 113114130

(51) Int. Cl. C08L 63/00; C08J 5/24; C08K 9/04

(52) U.S. Cl. CPC C08L 63/00; C08J 5/244; C08J 5/249; C08K 9/04; C08J 2363/00; C08J 2483/06; C08J 2483/08

(57) ABSTRACT

A resin composition includes a resin, a filler, and a polysiloxane compound. The resin includes an epoxy resin, a bismalcimide resin, a hardener, or a combination thereof. An equivalent number of the polysiloxane compound is greater than or equal to 1000 g/mol.

### CROSS-REFERENCE TO RELATED APPLICATION

This application claims the priority benefit of Taiwan application serial no. 113114130, filed on Apr. 16, 2024. The entirety of the above-mentioned patent application is hereby incorporated by reference herein and made a part of this specification.

### BACKGROUND OF THE INVENTION

### Field of the Invention

The invention relates to a resin composition.

### Description of Related Art

Fillers are often added to current resin compositions. However, since fillers are readily settled, the resin compositions may have issues such as difficulty in transportation, storage, or even processing, affecting production efficiency and yield. Therefore, how to improve the suspension of the filler of the resin composition while maintaining the performance of the finished substrate is an important issue in technological development.

### SUMMARY OF THE INVENTION

The invention provides a resin composition that may improve the suspension of a filler while maintaining the performance of the finished substrate.

A resin composition of the invention includes a resin, a filler, and a polysiloxane compound. The resin includes an epoxy resin, a bismaleimide resin, a hardener, or a combination thereof. An equivalent number of the polysiloxane compound is greater than or equal to 1000 g/mol.

In an embodiment of the invention, the polysiloxane compound has a hydrogen bond.

In an embodiment of the invention, the polysiloxane compound has an amine group or a carboxyl group.

In an embodiment of the invention, the polysiloxane compound includes

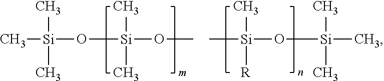

wherein R is, for example, CH₃, m may be between 1 and 15, and n may be between 1 and 15. Here, the m and n values influence the molecular weight and therefore influence the equivalent number.

In an embodiment of the invention, an equivalent number of the polysiloxane compound is less than or equal to 5000 g/mol.

In an embodiment of the invention, a weight proportion of the polysiloxane compound in the resin composition is between 0.1 wt % and 10 wt %.

In an embodiment of the invention, a weight proportion of the filler in the resin composition is greater than or equal to 75 wt %.

In an embodiment of the invention, a weight proportion of the filler in the resin composition is between 60 wt % and 80 wt %.

In an embodiment of the invention, the filler has an epoxy group or an amine group.

In an embodiment of the invention, a weight proportion of the epoxy resin in the resin is between 1 wt % and 10 wt %, a weight proportion of the bismaleimide resin in the resin is between 10 wt % and 20 wt %, and a weight proportion of the hardener in the resin is between 3 wt % and 10 wt %.

Based on the above, in the invention, the filler in the resin composition is coated and driven to move using the macromolecular polysiloxane compound to improve thixotropy and viscosity, and at the same time, the macromolecular polysiloxane compound does not have significant adverse effects on subsequent substrate properties. Therefore, the suspension of the filler is improved while maintaining the performance of the finished substrate.

In order to make the aforementioned features and advantages of the disclosure more comprehensible, embodiments accompanied with figures are described in detail below.

### DESCRIPTION OF THE EMBODIMENTS

In the following detailed description, for purposes of illustration and not limitation, exemplary embodiments disclosing specific details are set forth in order to provide a thorough understanding of the various principles of the invention. It will be apparent, however, to one of ordinary skill in the art, having the benefit of this disclosure, that the invention may be practiced in other embodiments that depart from the specific details disclosed herein.

Unless otherwise stated, the term “between” used in this specification to define numerical ranges is intended to cover ranges equal to and between the stated endpoints. For example, if a size range is between a first value and a second value, it means that the size range may cover the first value, the second value, and any value between the first value and the second value.

Unless otherwise defined, all terms (including technical and scientific terms) used herein have the same meaning as commonly understood by those skilled in the art to which this invention belongs.

In the present embodiment, the resin composition includes a resin, a filler, and a polysiloxane compound, wherein the resin includes an epoxy resin, a bismaleimide resin, a hardener, or a combination thereof. Furthermore, the equivalent number of the polysiloxane compound is greater than or equal to 1000 grams/mol (g/mol). In this way, the filler in the resin composition may be coated and driven to move using a macromolecular polysiloxane compound to improve thixotropy and viscosity, and at the same time, the macromolecular polysiloxane compound does not have significant adverse effects on subsequent substrate properties. Therefore, the suspension of the filler is improved while maintaining the performance of the finished substrate.

For example, the polysiloxane compound has a hydrogen bond. There are a plurality of functional groups with stronger bonding force in the compound to strengthen the connection network, increase the viscosity, and reliably coat the filler. Therefore, settlement may be reduced when stationary, and when needed, a lower viscosity state may be achieved again with proper stirring, which has advantages in production efficiency and yield, but the invention is not limited thereto.

Moreover, the equivalent number of the polysiloxane compound may be less than or equal to 5000 g/mol, that is, the equivalent number of the polysiloxane compound may be between 1000 g/mol and 5000 g/mol to achieve better suspension effect. However, the invention is not limited to this upper limit value. An appropriate value may be selected as the upper limit value according to actual design requirements. As long as the equivalent number of the polysiloxane compound meets the lower limit (greater than or equal to 1000 g/mol), the technical effect of improving suspension properties may be achieved.

In recent years, semiconductor development has gradually moved toward heterogeneous integration to improve efficiency, wherein the core technique is advanced packaging. In advanced packaging, there are higher requirements for accuracy and reliability, and the substrate made of the resin composition of the present embodiment may more appropriately meet the above requirements, but the invention is not limited thereto.

In some embodiments, the polysiloxane compound has an amine group or a carboxyl group to improve the compatibility thereof with the resin and/or further reduce the fluidity of the overall resin composition, but the invention is not limited thereto.

In some embodiments, the polysiloxane compound includes

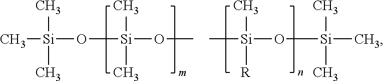

wherein R is an organic group, such as CH₃, m may be between 1 and 15, and n may be between 1 and 15, but the invention is not limited thereto. Here, the m and n values influence the molecular weight and therefore influence the equivalent number.

In some embodiments, the weight proportion of the polysiloxane compound in the resin composition is between 0.1 wt % and 10 wt %, but the invention is not limited thereto.

In some embodiments, the weight proportion of the filler in the resin composition is greater than or equal to 75 wt %, or the weight proportion of the filler in the resin composition is between 60 wt % and 80 wt %. When such a large proportion of the filler is added, the suspension issue is more significant, so the design adopting the present embodiment has more advantages, but the invention is not limited thereto.

In some embodiments, the filler has an epoxy group or an amine group to improve compatibility with the resin. For example, the filler includes silica, nitride, alumina, and aluminum nitride, wherein the particle size range of the filler may be between 0.01 micrometers and 5 micrometers, but the invention is not limited thereto. The particle size range of the filler may be determined according to actual design requirements.

In some embodiments, the weight proportion of the epoxy resin in the resin is between 1 wt % and 10 wt % (such as 1 wt %, 5 wt %, 7 wt %, 10 wt %, or any appropriate value between 1 wt % and 10 wt %), the weight proportion of the bismaleimide resin in the resin is between 10 wt % and 20 wt % (such as 10 wt %, 12 wt %, 15 wt %, 20 wt %, or any appropriate value between 10 wt % and 20 wt %), the weight proportion of the hardener in the resin is between 3 wt % and 10 wt % (such as 3 wt %, 5 wt %, 7 wt %, 10 wt %, or any appropriate value between 3 wt % and 10 wt %), but the invention is not limited thereto.

In some embodiments, the weight proportion of the bismaleimide resin in the resin is greater than the weight proportion of the epoxy resin in the resin and greater than the weight proportion of the hardener in the resin, but the invention is not limited thereto.

In some embodiments, the resin is only composed of the epoxy resin, the bismaleimide resin, and the hardener. In other words, the total weight proportion of the epoxy resin, the bismaleimide resin, and the hardener in the resin is 100 wt %, but the invention is not limited thereto.

In some embodiments, the epoxy resin includes an epoxy resin having a biphenyl structure, a naphthalene structure, or the like.

In some embodiments, the bismaleimide (BMI) resin includes BMI-1000 (CAS NO: 13676-54-5), BMI-2000 (CAS NO: 67784-74-1), BMI-2300 (CAS NO: 67784-74-1), BMI-3000 (CAS NO: 3006-93-7), BMI-4000 (CAS NO: 79922-55-7), BMI-5100 (CAS NO: 105391-33-1), BMI-7000 (CAS NO: 6422-83-9), or the like.

In some embodiments, the hardener includes an acid anhydride such as phenolic novolac resin, cresol novolac resin, bisphenol A novolak resin, benzoxazine resin, biphenyl novolac type phenolic resin, aminotriazine novolac type phenolic resin, pyromellitic anhydride, trimellitic anhydride, benzophenonetetracarboxylic acid.

In some embodiments, the resin composition is composed of the resin, the filler, and the polysiloxane compound. In other words, the total weight proportion of the resin, the filler, and the polysiloxane compound in the resin composition is 100 wt %, but the invention is not limited thereto.

It should be noted that the resin composition of the invention may be processed into a prepreg and a copper foil substrate (CCL) according to actual design requirements, and the specific implementations listed above are not limitations of the invention. Any situation in which the resin composition includes the polysiloxane compound is within the scope of the invention.

The following examples and comparative examples are given to illustrate the effects of the invention, but the scope of the invention is not limited to the scope of the examples.

The substrate produced in each example and comparative example was evaluated by the following method.

The glass transition temperature (° C.) was tested with a dynamic mechanical analyzer (DMA).

Coefficient of thermal expansion (CTE): the coefficient of thermal expansion of the material was measured at 50° C. to 120° C. (x-y plane direction) via TMA.

Water absorption (%): after heating the sample in a pressure cooker at 120° C. and 2 atm for 120 minutes, the weight change before and after heating was calculated.

Time left in suspension: the varnish was placed on a Turbiscan dispersion stability analyzer to measure the time the varnish remained in a well-dispersed state. (Measurement points, 5 minutes/time).

### Examples 1 to 4, Comparative Example 1

The varnish formed by leaving the resin composition shown in Table 1 in suspension for a certain period of time was impregnated with Nan Ya fiberglass cloth (Nan Ya Plastics Corporation, cloth type 2118S) at room temperature, then dried at 120° C. (impregnation machine) for a few minutes to obtain a prepreg with a resin content of 50 wt %. A constant temperature was maintained for 20 minutes at a pressure of 25 kg/cm² and a temperature of 85° C., then the temperature was increased to 250° C. at a heating rate of 3° C./min, and then the temperature was kept constant for 120 minutes, then cooling was slowly performed to obtain a copper foil substrate, and then the surface copper foil was removed to form a bare board, and various properties were evaluated. The physical properties of the produced copper foil substrate were tested, and the results thereof are shown in Table 1. After comparing the results of Examples 1 to 4 and Comparative example 1 of Table 1, the following conclusions may be drawn: compared with the substrate made in Comparative example 1, even if the resin compositions of the substrates made in Examples 1 to 4 were left to be suspended for two weeks or more, the performance of the substrate (such as glass transition temperature, coefficient of thermal expansion, water absorption, etc.) was still not significantly affected. Therefore, adding a polysiloxane compound with an equivalent number of at least greater than 1000 g/mol may indeed improve the suspension of the filler while maintaining the performance of the finished substrate.

TABLE 1

| | | | | | | | | | | | | Comparative | |
|---|---|---|---|---|---|---|---|---|---|---|---|---|---|
| | | Example | | | | | | | | | | example | |
| | | 1 | | 2 | | 3 | | 4 | | 5 | | 1 | |
| Resin | Epoxy resin (Nippon Kayaku NC-3500) | 3 | wt % | 3 | wt % | 3 | wt % | 3 | wt % | 2 | wt % | 3 | wt % |
| | Bismaleimide resin (BMI-1000) | 18.7 | wt % | 18.7 | wt % | 17.5 | wt % | 17.5 | wt % | 15.3 | wt % | 19.0 | wt % |
| | Hardener (benzoxazine resin) | 3 | wt % | 3 | wt % | 3 | wt % | 3 | wt % | 2 | wt % | 3 | wt % |

| Filler (silica, particle size of 0.8 micrometers | 75 | wt % | 75 | wt % | 75 | wt % | 75 | wt % | 80 | wt % | 75 | wt % |
|---|---|---|---|---|---|---|---|---|---|---|---|---|
| (D50), modified functional group: epoxy group) | | | | | | | | | | | | |
| Polysiloxane compound (Shin-Etsu KF-101, | 0.3 | wt % | 0 | | 1.5 | wt % | 0 | | 0.3 | wt % | 0 | |
| functional group: epoxy group, equivalent | | | | | | | | | | | | |
| number: 1000 g/mol) | | | | | | | | | | | | |
| Polysiloxane compound (Shin-Etsu KF-864, | 0 | | 0.3 | wt % | 0 | | 1.5 | wt % | 0 | | 0 | |
| functional group: amine group, equivalent | | | | | | | | | | | | |
| number 5000 g/mol) | | | | | | | | | | | | |

| | | | | | | |
|---|---|---|---|---|---|---|
| Glass transition temperature (° C.) | 350 | 350 | 350 | 350 | 350 | 350 |
| Coefficient of thermal expansion (ppm/° C.) | 2.2 | 2.3 | 2.2 | 2.1 | 2.2 | 2.2 |
| Water absorption (%) | 0.3 | 0.3 | 0.3 | 0.3 | 0.3 | 0.3 |
| Time left in suspension (hours) | 400 | 360 | 540 | 600 | 48 | 48 |

Based on the above, in the invention, the filler in the resin composition is coated and driven to move using the macromolecular polysiloxane compound to improve thixotropy and viscosity, and at the same time, the macromolecular polysiloxane compound does not have significant adverse effects on subsequent substrate properties. Therefore, the suspension of the filler is improved while maintaining the performance of the finished substrate.

Although the invention has been described with reference to the above embodiments, it will be apparent to one of ordinary skill in the art that modifications to the described embodiments may be made without departing from the spirit of the invention. Accordingly, the scope of the invention is defined by the attached claims not by the above detailed descriptions.

What is claimed is:

1. A resin composition, comprising:
a resin comprising an epoxy resin, a bismaleimide resin, a hardener, or a combination thereof;
a filler; and
a polysiloxane compound, wherein an equivalent number of the polysiloxane compound is greater than or equal to 1000 g/mol.

2. The resin composition of claim 1, wherein the polysiloxane compound has a hydrogen bond.

3. The resin composition of claim 1, wherein the polysiloxane compound has an amine group or a carboxyl group.

4. The resin composition of claim 1, wherein the polysiloxane compound comprises 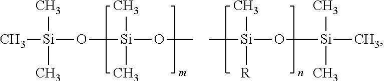
wherein R is CH₃, m may be between 1 and 15, and n may be between 1 and 15.

5. The resin composition of claim 1, wherein an equivalent number of the polysiloxane compound is less than or equal to 5000 g/mol.

6. The resin composition of claim 1, wherein a weight proportion of the polysiloxane compound in the resin composition is between 0.1 wt % and 10 wt %.

7. The resin composition of claim 1, wherein a weight proportion of the filler in the resin composition is greater than or equal to 75 wt %.

8. The resin composition of claim 1, wherein a weight proportion of the filler in the resin composition is between 60 wt % and 80 wt %.

9. The resin composition of claim 1, wherein the filler has an epoxy group or an amine group.

10. The resin composition of claim 1, wherein a weight proportion of the epoxy resin in the resin is between 1 wt % and 10 wt %, a weight proportion of the bismalcimide resin in the resin is between 10 wt % and 20 wt %, and a weight proportion of the hardener in the resin is between 3 wt % and 10 wt %.
